(19) United States
(12) Patent Application Publication
(10) Pub. No.: US 2011/0058917 A1
(43) Pub. Date: Mar. 10, 2011

(54) APPARATUS FOR PROCESSING BY MILLING THE SPINE REGION OF A BOOK BLOCK CLAMPED INTO A CONVEYING ARRANGEMENT CLAMPING DEVICE WITH THE OVERHANGING SPINE PROJECTING DOWNWARD

(75) Inventors: HARALD WALIAN, Newport News, VA (US); Joe Matalevich, Suffolk, VA (US); Peter Geiser, Matzingen (CH)

(73) Assignee: Mueller Martini Holding AG, Hergiswil (CH)

(21) Appl. No.: 12/556,265

(22) Filed: Sep. 9, 2009

(51) Int. Cl. B42C 5/00; B42B 9/00

(52) U.S. Cl. 412/1; 412/16; 269/55

(57) ABSTRACT

With an apparatus for the processing by milling of the overhanging spine (14) region of a book block (9), which is clamped into at least one clamping device (4) on a conveying arrangement (5) with the side to be processed pointing in downward direction, the book block (9) is moved along the conveying path past a rotary-driven processing tool (16) of a stationary processing station (6). The at least one clamping device (4) is attached to a rotating frame (3) that rotates around a perpendicular axis of rotation (2), wherein the clamping device is provided with an immovable clamping jaw (7) as well as an opposite-arranged movable clamping jaw (8) for opening and closing the clamping device (4). The apparatus is furthermore provided with a supporting member (19) that counteracts the cutting forces generated by the processing station (6), wherein the supporting member (19) assigned to the processing station (6) is mounted stationary and comprises a stabilizing element (20) that comes to rest against the clamping jaw (7, 8) of the clamping device (4) and is attached to a guide member (21) which supports the overhanging book block region.

### BACKGROUND OF THE INVENTION

The invention relates to an apparatus for processing by milling the spine region of a book block, which is clamped into at least one clamping device arranged on a conveying arrangement, such that the overhanging spine projects in downward direction. Along the conveying path, the book block is moved past a rotary-driven processing tool on a stationary processing station which acts upon the spine, wherein the at least one clamping device is attached to a rotating frame that rotates around a perpendicular axis of rotation and is provided with an immovable as well as a movable clamping jaw for the opening and closing of the clamping device, wherein the device furthermore comprises a supporting member that is designed to counteract the cutting forces generated by the processing station.

Apparatuses of the aforementioned type are used for the adhesive binding of printed sheets into book blocks, magazines, paperback books, telephone directories or similar printed products. In the process, the printed sheets are first gathered into loose, unbound book blocks and are then conveyed to the apparatus, a so-called perfect binder. A perfect binder of this type is disclosed, for example, in Swiss patent document CH 325 096. Clamping devices for clamping in the unbound book blocks with the spines pointing downward are arranged uniformly spaced apart along a carousel table rotating around a vertical axis. During a rotation of the carousel table, the unbound book blocks held by the clamping jaws are processed or adhesive-bound along the spine area with the aid of processing stations attached to a stationary machine frame, and if applicable, are provided with a fold or a cover. Following the feeding operation, the unbound book blocks, positioned to rest on the spines, are transferred to a vibrating table and the spine areas of the printed sheets are uniformly aligned. The clamping device, which consists essentially of an immovable and a movable clamping jaw, is subsequently closed so that the spine area to be milled off projects from the clamping jaws. In the following milling station, a specified area of the spine is milled off with the aid of a milling machine positioned directly below the clamping jaws, wherein the clamping jaws form supporting members which counteract the cutting forces generated in the processing station.

Using the above-described perfect binder, it is necessary to adjust the shortest possible distance between the milling machine and the clamping jaws to avoid the danger otherwise present at the milling machine discharge side that the sheets of the book block are pushed away by the milling forces and are bent around the clamping jaw. The clamping device opens up again above a following alignment table, so that after the alignment the book block spines project far enough from the clamping jaws of the clamping devices to allow access to the side areas near the spine for subsequent processing operations, in particular for applying adhesive to the side areas and for pressing a backing strip or the cover on the sides. A disadvantage of the prior art is that following the opening of the clamp, the outermost pages resting directly against the clamping jaws can adhere to the clamping jaws as a result of friction or an electrostatic charge, thereby making it impossible to ensure a perfect alignment of the book blocks and resulting in insufficient quality for the printed products or even a rejection. A further disadvantage is the large space requirement for the alignment table as well as the expenditure for its production.

### SUMMARY

It is an object of the present invention to provide an apparatus of the aforementioned type, for which the currently required operation of opening the clamping device to apply adhesive to the flanks of the book block spine can be eliminated.

The above and other objects are accomplished according to one aspect of the invention wherein there is provided a device for processing by milling of a spine of a book block which, according to one embodiment, includes a conveying arrangement including a rotating frame that rotates around a perpendicular axis of rotation and at least one clamping device attached to the rotating frame to clamp the book block such that the spine projects downward to present an overhang portion in a processing direction along a conveying path, wherein the at least one clamping device comprises an immovable clamping jaw and an opposite-arranged, movable clamping jaw to open and close the at least one clamping device; a stationary processing station including a rotary driven processing tool positioned along the conveying path to process the downward-projected spine of the book block in a processing region; and a first supporting member assigned to the processing station to counteract cutting forces generated by the processing station, wherein the supporting member is rigidly mounted at a fixed location and includes a guide member that supports the overhang portion of the book block in the processing region and a stabilizing element that rests against at least one of the immovable or moveable clamping jaws of the at least one clamping device and is attached to the guide member.

### BRIEF DESCRIPTION OF THE DRAWINGS

The present invention will be more readily understood from the following detailed description when read in conjunction with the accompanying drawings, in which:

FIG. 1 depicts a top view of a perfect binder provided with an apparatus according to an embodiment the present invention to process a book block spine at the start of the milling operation;

FIG. 2 depicts an apparatus according to FIG. 1, shown following the start of the milling operation;

FIG. 3 depicts an apparatus according to FIG. 1 at the end of the milling operation;

FIG. 4 depicts a top view of a perfect binder, provided with an alternative apparatus according to another embodiment of the invention to process a book block spine during the milling operation;

FIG. 5 depicts a top view of a perfect binder according to an alternative embodiment provided with an alternative apparatus to process the book block spine during the milling operation;

FIG. 6 depicts an apparatus according to FIG. 5 at the end of the milling operation;

FIG. 7 depicts a cross sectional view through the apparatus according to FIG. 1;

FIG. 8 depicts a top view of an apparatus for the processing by milling of a book block spine, according to an embodiment of the present invention; and

FIG. 9 depicts a side view of the apparatus as shown in FIG. 8.

### DETAILED DESCRIPTION

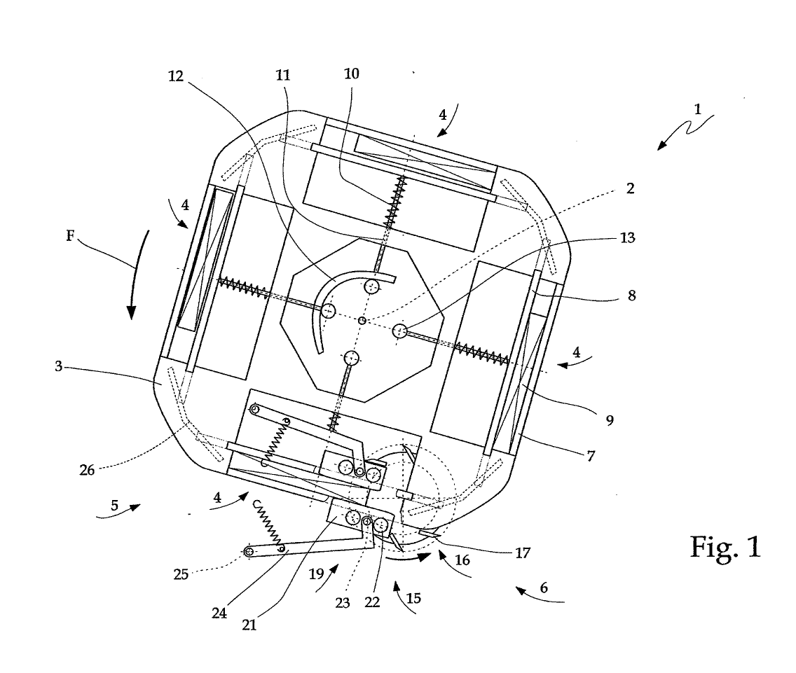

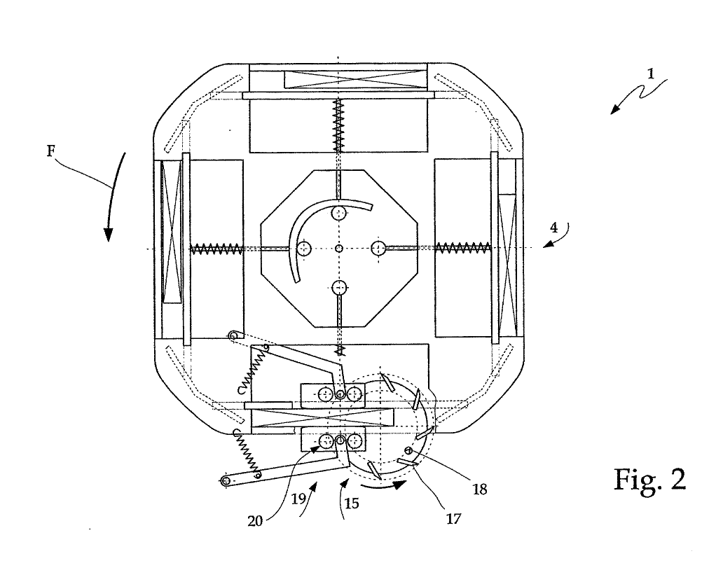

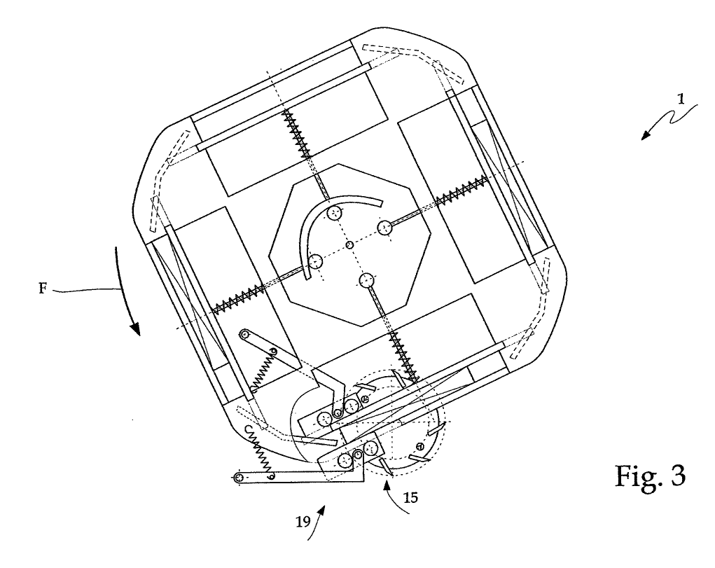

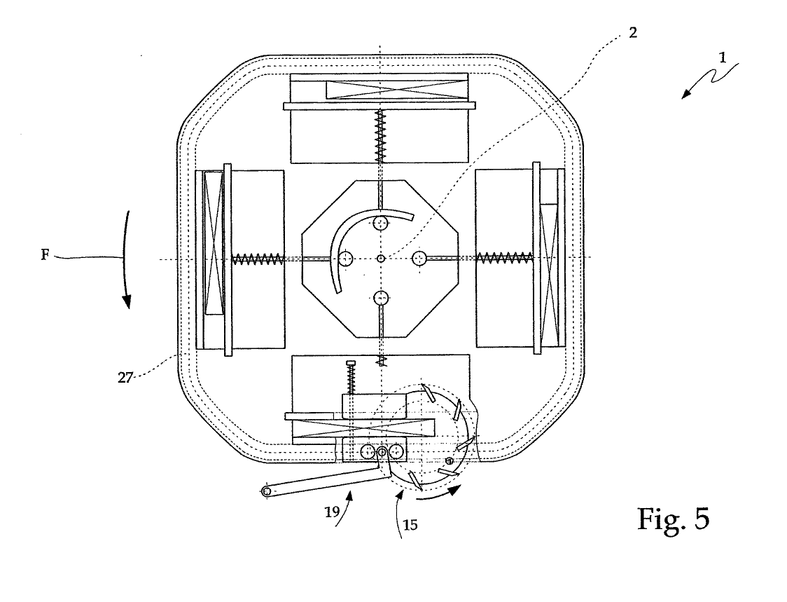

FIGS. 1 to 6 show an apparatus 15 for the processing by milling of the spine 14 of a book block 9 inside a perfect binder 1, wherein this apparatus may include a rotating frame 3 that rotates around a perpendicular axis of rotation 2 and is provided along the periphery with uniformly spaced-apart clamping devices 4 that jointly form a conveying arrangement 5, as well as stationary processing stations 6. The rotating frame 3 shown in each of the Figures is respectively provided with four clamping devices 4. However, the number of clamping devices 4 is not essential to the invention and can be selected optionally.

Each clamping device 4 comprises an immovable clamping jaw 7 and a movable clamping jaw 8, arranged opposite each other, between which the book blocks 9 can be clamped in. The immovable clamping jaw 7 is rigidly connected to the rotating frame 3 while the movable clamping jaw 8 is guided so as to be displaceable along the rotating frame 3, transverse to the flat sides of the book block 9. In the Figures, the immovable jaw 7 is always shown on the outside while the movable jaw 8 is always shown on the inside. However, it depends on the configuration of the perfect binder 1 which clamping jaw 7, 8 is located on the inside and which clamping jaw is located on the outside and is not important to the invention. With the aid of compression springs 10 that are supported on the rotating frame 3, the movable clamping jaw 8 is tensioned against the immovable clamping jaw 7 and the book block 9 is thus clamped in. The clamping device 4 is opened with the aid of a cam roller 13 that operates jointly with a stationary control cam 12 and is arranged at the end of a guide rod 11, which is connected to the movable clamping jaw 8.

The stationary processing stations 6 for processing the spines 14 of the book blocks 9 are successively arranged in conveying direction F below the conveying arrangement 5, wherein these processing stations process the book blocks 9 while the conveying arrangement 5 is operational or standing still. A complete processing cycle may involve the following operations: supplying a clamping device 4 with a book block 9, for which the book block 9 is positioned with the spine 14 resting on a table; closing of the clamping device 4; milling of the spine 14 of the book block 9 and, if applicable, notching of the spine 14; applying adhesive to the spine and to the sides and, if applicable, also creating a fold and/or attaching a cover to the spine 14 of the book block 9 as well as pressing it against the sides; opening of the clamping device 4 for the purpose of conveying the bound printed product or the untrimmed, unfinished product to further processing stations.

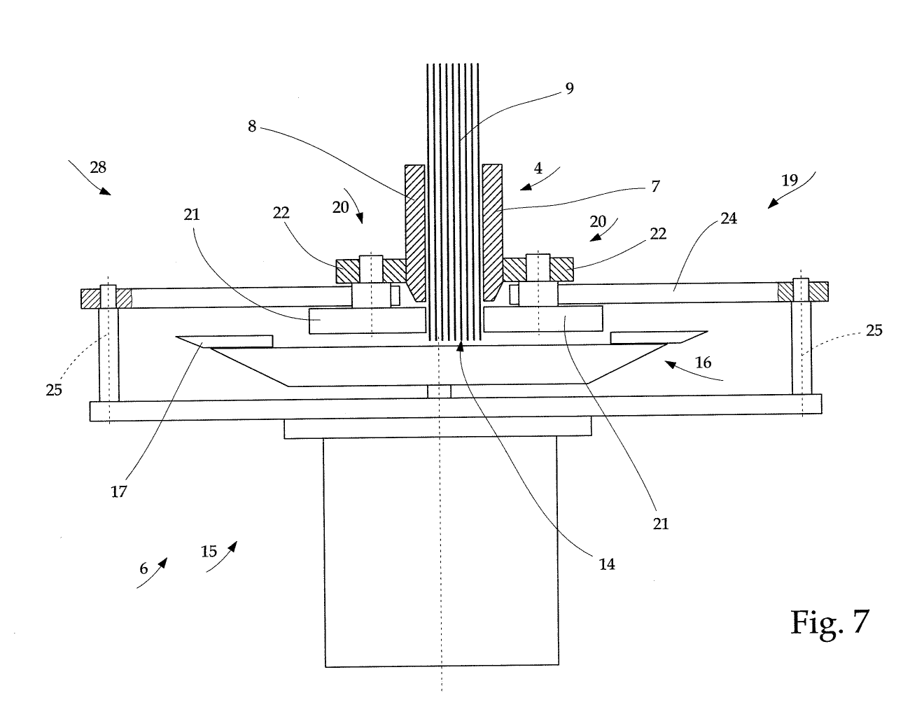

According to an embodiment of then invention, an apparatus for the processing by milling of the spine 14 of a book block 9 conveyed with the overhanging spine projecting in downward direction from the clamping device 4 on the conveying arrangement 5, is assigned to a milling station 15. On the upper end of a perpendicular shaft, the apparatus is provided with a processing tool 16 that operates at high speeds and to which are attached cutting blades 17 or notching blades 18. Furthermore provided is a supporting member 19 that counteracts the cutting forces generated by the processing tool 16 at a clamping jaw 7, 8 of the clamping device 4 and functions to guide the projecting book block spine region on the side. The supporting member 19 that is assigned to the processing station 6 is arranged locally fixed and is provided with a stabilizing element 20 that fits against the clamping jaw 7, 8 of the clamping device 4 and is attached to a guide member 21 for supporting the projecting region of the book block. The stabilizing element 20 comprises two frictionally adhering, freely rotating guide rolls 22 or a guide surface 30 that faces the clamping jaw 7, 8. The supporting member 19 can be pivoted around an axis 23, arranged substantially perpendicular to the conveying path, thereby ensuring that in the region of the clamping jaws 7, 8, the supporting member 19 automatically aligns itself parallel to the clamping jaws 7, 8. To compensate for the constantly changing distance resulting from the polygonal effect between the axis of rotation 2 for the rotating frame 3 and the clamping jaw 7, 8 of the clamping device 4, the supporting member 19 is arranged movable in radial direction, relative to the axis of rotation 2. In FIGS. 1 to 8, this movement is achieved with a lever 24, positioned to pivot around an axis 25 that is arranged perpendicular to the conveying path for the book blocks 9. Also conceivable is the use of a linear guide, disclosed in the art, or a movement along an optional curved path, provided the supporting function is ensured during the processing.

Guide segments 26 are arranged for guiding the supporting member 19 between the clamping jaws 7, 8. These guide segments 26 together with the clamping jaws 7, 8 form a closed control path 27 around the rotational axis 2 of the rotating frame 3. To ensure that the supporting member 19 precisely follows the control path 27, it is pressed with a spring force against the control path 27. The distance between the axis for the milling machine 15 and the rotational axis 2 is selected such that the conveying path for the clamping device 4 in the processing region extends approximately at a right-angle to the processing direction of the processing tools 16. The supporting member 19 should at least be long enough so that its effect extends over the processing region of the processing tool 16 along the conveying path.

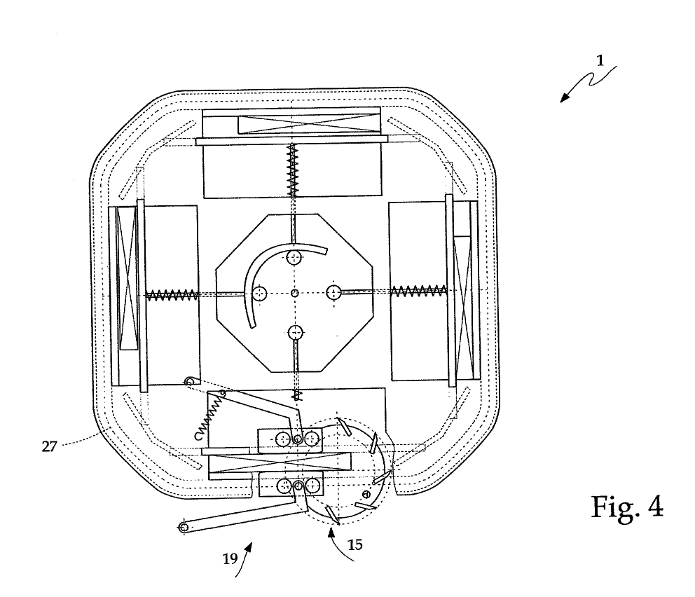

FIG. 4 shows a supporting member 19 resting against the clamping jaw 7, 8 as a result of the closed control path 27. The closed control path 27 has the advantage that the supporting member 19 is forcibly moved, that the milling forces can be supported positively and that no spring action is needed. An additional supporting member 28 can be assigned on the side opposite the supporting member 19 to the clamping jaw 7, 8 of the clamping device 4 in order to guide the book block 9, which ensures that the book block 9 is in an unambiguous position during the processing and that consequently a geometrically precise surface can be obtained for the book block spine 14.

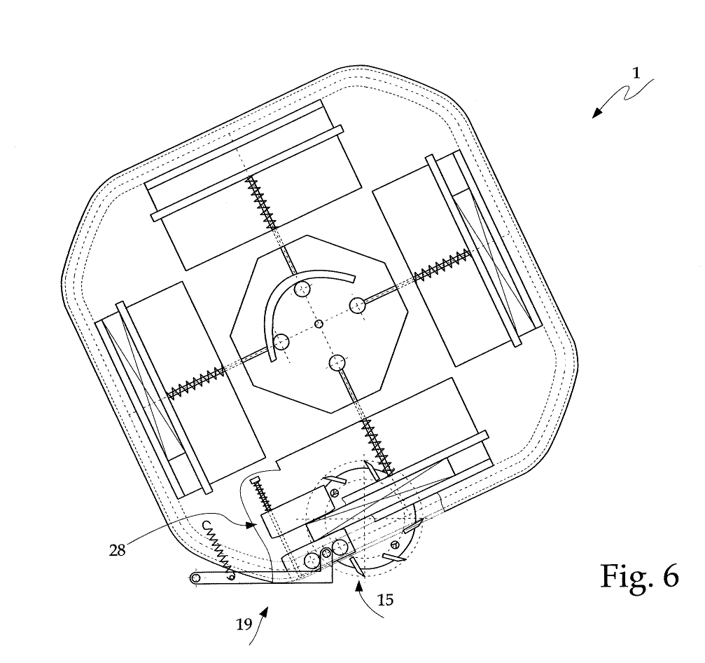

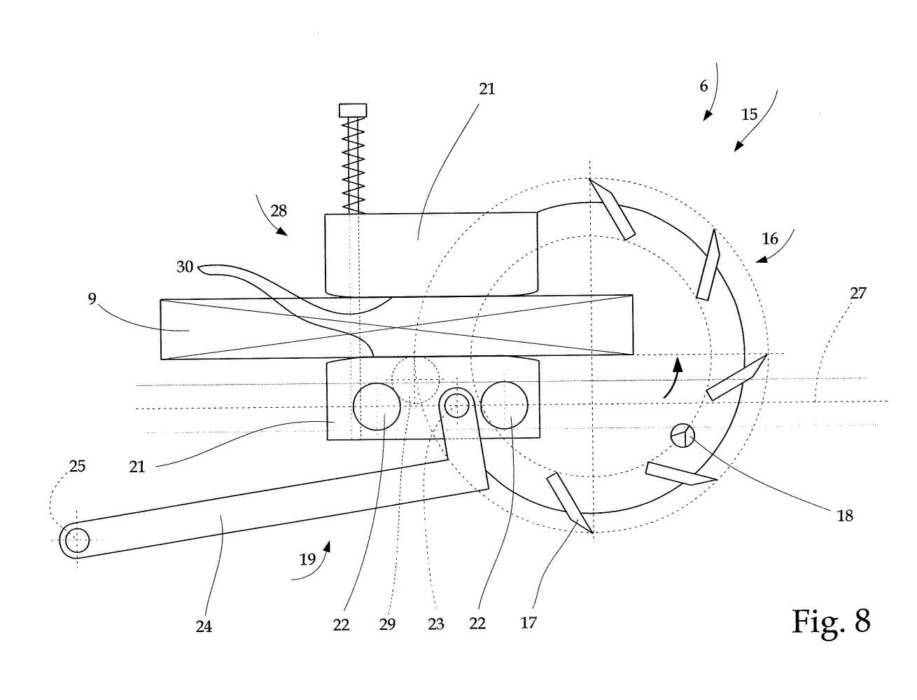

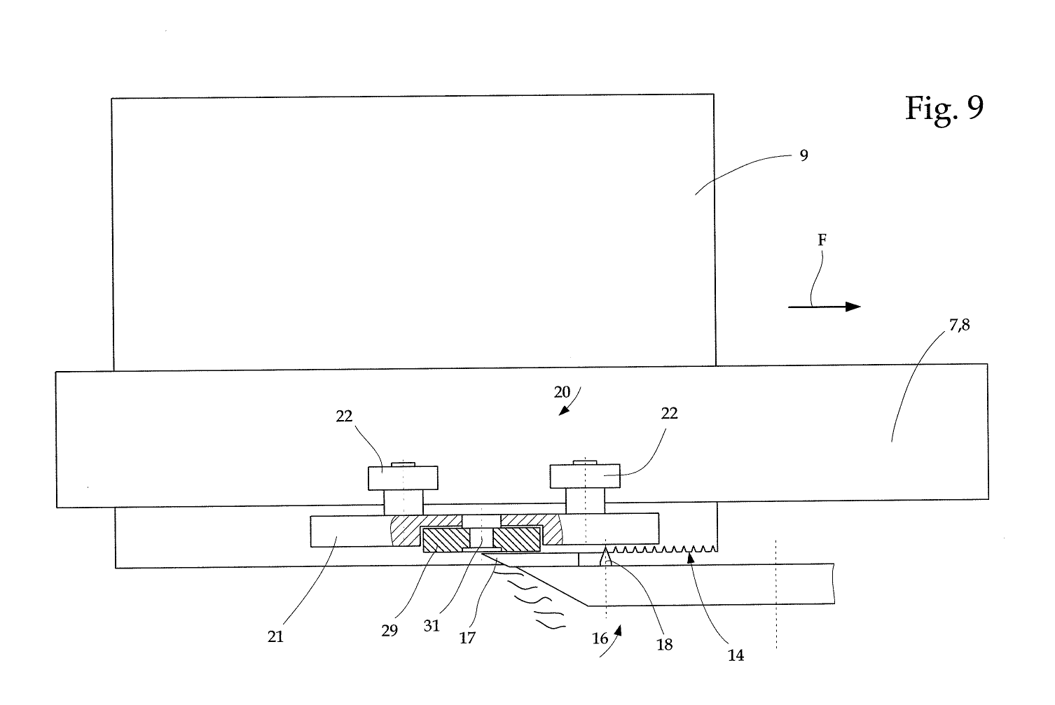

FIG. 6 shows a different supporting member 28 that is assigned to the supporting member 19 and is connected thereto. The supporting members 19, 28 can be operated jointly and at least one of the supporting members 19, 28 is assigned to a clamping jaw 7, 8 in a direction substantially perpendicular to the conveying path of the book block 9. FIGS. 8 and 9 furthermore show a different embodiment of a supporting member 19, for which at least one guide roll 29 of a supporting member 19 is arranged in the processing region of the processing tool 16 so that it can act upon the projecting book block region of the book block 9. The guide roll 29 may be positioned on the guide member 21 to rotate around an axis 31, arranged perpendicular to the conveying path. The forces generated during the processing consequently act counter to the guide roll 29. In this way, the frictional forces created during the supporting function can be reduced considerably between the book block 9 and the supporting member 19 or the guide member 21 and damage to the outermost page of the book block 9 can be avoided.

Also conceivable is a different embodiment, for which one or both supporting members 19, 28 are operated with the aid of an electric motor, not shown herein, for example a servomotor. In that case, a motor can be used to rotate the supporting members 19, 28 around the axis 25 or the axis 23.

While several embodiments of the invention are described above, it should be understood that the foregoing is presented by way of example only, and not limitation. Thus, the breadth and scope of the invention should not be limited by the above-described embodiments, but should instead be defined only in accordance with the following claims and their equivalents.

1. An apparatus for processing by milling of a spine of a book block, comprising:
a conveying arrangement including a rotating frame that rotates around a perpendicular axis of rotation and at least one clamping device attached to the rotating frame to clamp the book block such that the spine projects downward to present an overhang portion in a processing direction along a conveying path, wherein the at least one clamping device comprises an immovable clamping jaw and an opposite-arranged, movable clamping jaw to open and close the at least one clamping device;
a stationary processing station including a rotary driven processing tool positioned along the conveying path to process the downward-projected spine of the book block in a processing region; and
a first supporting member assigned to the processing station to counteract cutting forces generated by the processing station, wherein the supporting member, is rigidly mounted at a fixed location and includes a guide member that supports the overhang portion of the book block in the processing region and a stabilizing element that rests against at least one of the immovable or moveable clamping jaws of the at least one clamping device and is attached to the guide member.

2. The apparatus according to claim 1, wherein the stabilizing element includes a sliding surface that faces at least one of the immovable or moveable clamping jaws.

3. The apparatus according to claim 1, wherein the stabilizing element includes at least two freely rotating support rolls, which rest frictionally adhering against at least one of immovable or moveable clamping jaws.

4. The apparatus according to claim 1, wherein the stabilizing element of the first supporting member is pivotable around an axis that is arranged perpendicular to the conveying path for the book blocks.

5. The apparatus according to claim 1, wherein the stabilizing element of the first supporting member is pivotable with the aid of a lever around an axis that is perpendicular to the conveying path of the book block, wherein the lever comes to rest against at least one of the immovable or moveable clamping jaws.

6. The apparatus according to claim 1, wherein the conveying path of the at least one clamping device in the processing region extends approximately at a right angle to the processing direction of the processing tool.

7. The apparatus according to claim 6, wherein the first supporting member extends at least approximately over the processing region of the processing tool along the conveying path.

8. The apparatus according to claim 1, wherein the first supporting member is positioned with the aid of a spring force against at least one of the immovable or moveable clamping jaws.

9. The apparatus according to claim 1, further comprising a closed control cam positioned around the axis of rotation of the rotating frame, wherein the first supporting member is positioned against one of the immovable or moveable clamping jaws with the aid of the closed control cam.

10. The apparatus according to claim 1, further comprising a second supporting member coupled to the opposite arranged, movable clamping jaw of the at least one clamping device.

11. The apparatus according to claim 10, wherein the second supporting member is coupled to the first supporting member and the first supporting member is coupled to the immovable clamping jaw.

12. The apparatus according to claim 10, wherein the first and second supporting members are operated jointly.

13. The apparatus according to claim 10, wherein at least one of the first and second supporting members is arranged to act upon one of the immovable or moveable clamping jaws in a direction perpendicular to the conveying path of the book block.

14. The apparatus according to claim 10, wherein at least one of the first or second supporting members includes at least one guide roll arranged in the processing region for the processing tool, to act upon the overhang portion of the book block.

15. The apparatus according to claim 14, further comprising a guide member on which the at least one guide roll is arranged, wherein the at least one guide roll is positioned such that it can rotate freely around an axis that is perpendicular to the conveying path.

16. A method for producing printed products on a perfect binding machine, which comprises utilizing the apparatus according to claim 1.
